(19) United States
(12) Patent Application Publication
(10) Pub. No.: US 2009/0164498 A1
(43) Pub. Date: Jun. 25, 2009

(54) SYSTEM AND METHOD FOR CREATING RELATIONSHIP VISUALIZATIONS IN A NETWORKED SYSTEM

(75) Inventor: Ryan Melcher, Ben Lomond, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., San Jose, CA (US)

(21) Appl. No.: 11/961,009

(22) Filed: Dec. 20, 2007

(51) Int. Cl. G06F 17/30

(52) U.S. Cl. 707/102; 707/E17.065

(57) ABSTRACT

A computer-implemented system and method for creating relationship visualizations in a networked system are disclosed. The apparatus in an example embodiment includes a relationship visualization generator configured to obtain information related to the status of a relationship associated with a subject entity; create a relationship visualization defining the status of the subject entity, the relationship visualization including a first image corresponding to the subject entity and a second image corresponding to a verb describing the subject entity; and render the relationship visualization in real time.

### BACKGROUND

1. Technical Field

This disclosure relates to networked systems. More particularly, the present disclosure relates to creating relationship visualizations in a networked system.

2. Related Art

Visual representations of information have been shown to decrease the amount of time an analyst spends reading and sorting information and increase the speed of understanding the conveyed concepts. Visual representations may also lead to the discovery of insight not previously anticipated. Many visual representations have been implemented, each with certain limitations. Keywording is quite common and well known, but has the limitation that an analyst must still do a significant amount of reading to understand the conveyed concept. Artificial intelligence and/or natural language processing has been employed with limited success and with limited speed in part because of complexity of operation of these tools.

U.S. Pat. No. 6,897,866 discloses a method and apparatus for visualizing a relationship between at least two entities, by: (a) geometrically mapping the at least two entities onto a surface; (b) providing a relationship record for each of the at least two entities; (c) generating a display of the at least two entities together with at least one connector between the at least two entities as the visualizing the relationship from the relationship record; (d) the connector having two ends connected to a pair of the at least two entities, the connector having an extension between the two ends, the extension passing out of the plane. The present invention provides the improvement of: for at least one pair of entities, the at least one pair having a plurality of relationships, the connector having a plurality of strands wherein each of the plurality of strands corresponds to each of the plurality of relationships.

However, current systems do not provide a means or method for graphically representing the nature of the relationship between two entities in real time. Thus, a computer-implemented system and method for creating relationship visualizations in a networked system is needed.

### BRIEF DESCRIPTION OF THE DRAWINGS

Embodiments illustrated by way of example and not limitation in the figures of the accompanying drawings, in which:

FIG. 1 illustrates an example embodiment of a networked system in which various embodiments may operate

FIG. 2 illustrates an example screenshot of a relationship visualization page showing a set of graphically depicted relationship visualizations, most including a subject image, a predicate image, and a verb or action image.

FIG. 3 illustrates a sample screenshot of other examples of the relationship visualizations of a particular embodiment.

FIG. 4 is a processing flow diagram of an example embodiment.

FIG. 5 shows a diagrammatic representation of a machine in the form of a computer system within which a set of instructions, for causing the machine to perform any one or more of the methodologies discussed herein, may be executed, according to an example embodiment.

### DETAILED DESCRIPTION

A computer-implemented system and method for creating relationship visualizations in a networked system are disclosed. In the following description, numerous specific details are set forth. However, it is understood that embodiments may be practiced without these specific details. In other instances, well-known processes, structures and techniques have not been shown in detail in order not to obscure the clarity of this description.

As described further below, according to various example embodiments of the disclosed subject matter described and claimed herein, there is provided a computer-implemented system and method for creating relationship visualizations in a networked system. Various embodiments are described below in connection with the figures provided herein.

### Overview of Various Embodiments

In a particular example embodiment, the relationship visualization functionality is implemented in a set of processing modules. In the example embodiment, these modules include: a commerce relationship visualization generator and a social relationship generator. Each of these modules are described in the sections of this document below. It will be apparent to those of ordinary skill in the art upon understanding this disclosure that the generation of visualizations for other types of relationships are also possible.

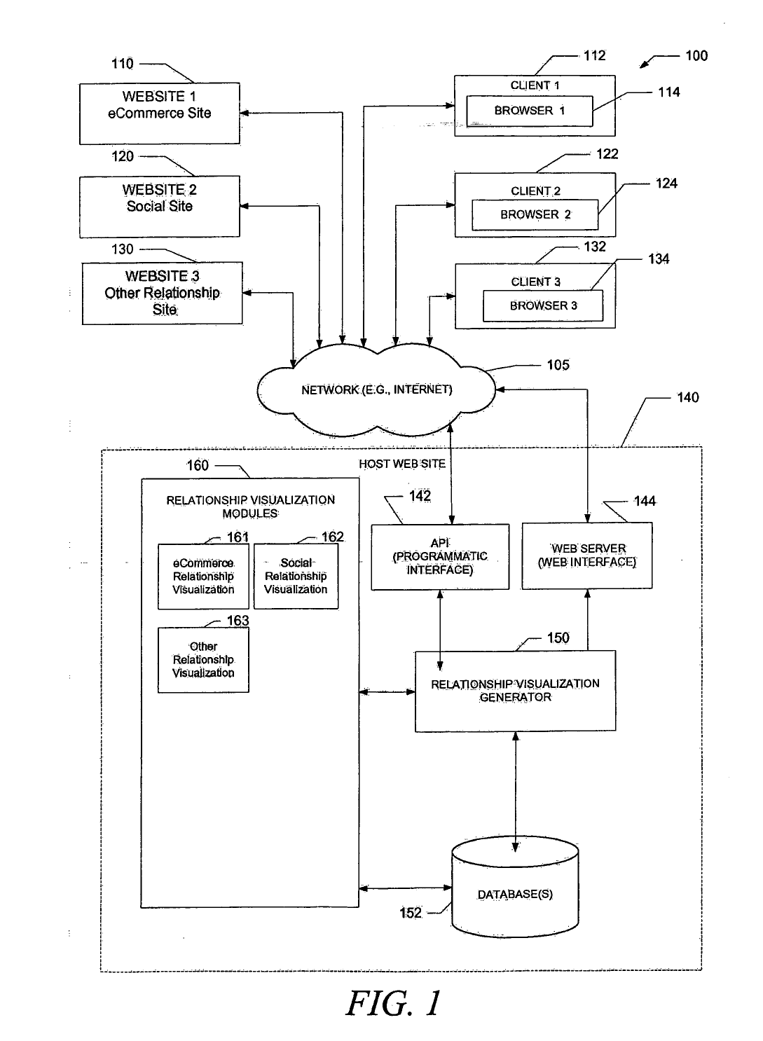

Referring to FIG. 1, an example networked system 100 in which various embodiments may operate is illustrated. As shown, various users of client systems 112, 122, and 132 using browsers 114, 124, and 134 can communicate with and interact with various websites 110, 120, and 130 via a network 105, such as the Internet. Using well known protocols (e.g. HTTP) and user interfaces, users can consume and create content on various websites 110, 120, and 130 and perform commercial transactions (e.g. purchase/lease products and services, bid on products/services, etc.) on various websites, such as website 110. Similarly, users can perform social interactions on various websites, such as website 120. Other relationship interactions can be served to users of client systems 112, 122, and 132 from website 130.

The content created and/or maintained by users or websites can be in a variety of forms. The interactions between users or between entities can also vary greatly. Further, these relationships between users or entities can change rapidly in real time. It would be advantageous for users to be able to see the current status of these relationships at a glance in real time. It would be advantageous to provide users with a graphical visual representation of the current status of these relationships in real time. Particular embodiments described herein seek to gather relationship information content in various forms and render the relationship information in a visual form that conveys to interested users the status of these relationships in real time.

Referring still to FIG. 1, a host website 140 may host the relationship visualization functionality of various embodiments. A relationship visualization generator 150 provides a control mechanism to receive user requests via web server interface 144 or application programming interface (API) 142. As described in more detail below, such requests may be received in the form of a link provided on a web page of the host website 140. Activation of the link by a user of client systems 112, 122, and 132 causes activation of the relationship visualization engine 150 by the host website 140.

Depending upon the particular request issued by the user to the relationship visualization generator 150, the relationship visualization generator 150 can employ one or more of the relationship visualization modules 160 to service the request. For example, a user activation of a relationship visualization link may cause the display of a set of ecommerce relationship visualizations or social relationship visualizations (described in more detail below) as provided by corresponding modules 160.

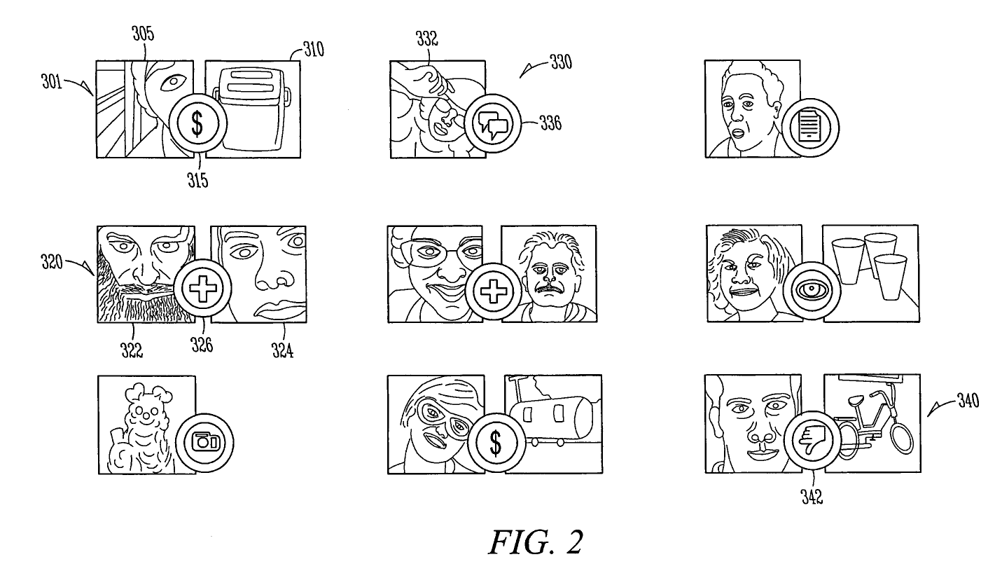

FIG. 2 illustrates an example screenshot of a relationship visualization page showing a set of graphically depicted relationship visualizations, most including a subject image, a predicate image, and a verb or action image. In a particular example embodiment described herein, we can represent relationships, actions, properties, and the like through a relationship visual sentence. Each relationship visual sentence can have two main parts: 1) a subject, and 2) a predicate. The subject includes an identification of a person, an object, an item, a property, a concept, or the like (generally, an entity). The predicate includes the combination of a verb that identifies an action or state of being and a direct object that identifies an entity to which the action relates. Together, the subject and predicate form a basic sentence construct, such as the following:

Subject>verb>direct object

As examples of the basic sentence construct of a particular embodiment, the following examples demonstrate simple sentences that convey a relationship between two entities and the status of the relationship:

Subject>verb>direct object
Rolf>likes>bicycles
Jake>fears>Ryan
John>bought>car
Jane>bid on>house
Jim>added to contact list>Mike
Jean>is shopping for>glasses

It will be apparent to those of ordinary skill in the art that many different types of relationships can be conveyed in the structure defined above. In addition, other sentence structures can be defined wherein the predicate does not include a direct object. Such sentence structures can convey the state of the subject entity. The following examples demonstrate this type of sentence structure in a particular embodiment:

Subject>verb>direct object
Mary>wants to chat
Sam>sent you an email or document

Using the basic sentence structures defined above, a system can use these types of sentences to describe a relationship between two entities and to convey the status of the relationship. In a particular embodiment, these sentences are further modified to replace text with images or animations that graphically convey the information without the use of text. Because the sentences thereby become graphic visualizations, the information can be more readily absorbed and understood by a user/viewer. In a particular embodiment, graphic images are used for the subject and predicate in the sentence structures described above. In various embodiments, the verbs used in the predicate can be converted to a variety of different images or graphic symbols. Several examples are set forth below.

Symbol=Verb
$=bid on or bought
+=added to contact list, buddy list, or neighborhood, etc.
‘Thumbs down image’=lost auction
‘Thumbs up image’=won auction
‘Eyeball image’=is looking at
‘Chat bubble image’=wants to chat or is chatting
‘Document bubble’=wants to email or is emailing
‘Lock image’=is unavailable
‘Heart image’=likes or loves

It will be apparent to those of ordinary skill in the art that may different types of actions or states of being can be conveyed using the images or symbols such as those defined above. Examples of these graphic visualizations that describe relationships between entities are shown in FIG. 2.

Referring to FIG. 2, examples of the graphic visualizations that describe relationships between entities are shown for a particular example embodiment. Each visualization represents a relationship between entities or the state of being of an entity. For example, visualization 301 includes a subject image 305 and a direct object image 310. A corresponding verb image 315 connects the subject and the direct object with an action or a state of being that defines the relationship between the subject entity and the direct object entity. In this particular example, the visualization conveys the relationship status that a man, represented by the subject image 305, has bid on or bought, as represented by the verb image 315, a toaster represented by the direct object image 310. In a second example shown in FIG. 2 as visualization 320, a man, represented by the subject image 322, has added to a contact list, as represented by the verb image 326, a woman represented by the direct object image 324. In a third example shown in FIG. 2 as visualization 330, a woman, represented by the subject image 332, has indicated her desire to chat or is already chatting, as represented by the verb image 336. In a similar manner, a variety of other relationships between entities can be represented graphically with visualizations such as those shown by example in FIG. 2.

Additional information regarding the relationships shown as visualizations can be provided in a number of ways in particular embodiments. For example, color can be used to further indicate the status of an entity of a verb. For example, green can be used to convey a favorable, active, or positive status. Red can be used to convey an unfavorable, inactive, or negative status. As shown in FIG. 2, visualization 340 shows a ‘Thumbs down’ verb in red to indicate the item indicated in the predicate image has been lost at auction—a negative result. Variations in color are quickly understood by a viewer of the relationship status visualization.

Visualizations can be further modified to convey additional information. In an another example, the relative size of the image corresponding to the subject and/or predicate can be varied to convey the significance or intensity of the corresponding entity, action, or status. For example, a ‘Heart image’ can be used as a verb to indicate the subject entity, ‘likes or loves’ the direct object entity. The size of the ‘Heart image’ can be varied to indicate the intensity of the feeling; thus, a large ‘Heart image’ can indicate ‘love’ and a smaller relative ‘Heart image’ can indicate ‘like’. It will be apparent to those of ordinary skill in the art that other variations of the relationship images can also be used to convey additional information regarding the relationship.

Further, simple animations can also be used to convey additional information in regard to the relationship. In particular, the verb of a particular relationship visualization can be animated to provide additional information about the relationship. For example, a ‘Heart image’ can be animated to grow from a small ‘Heart image’ to a larger relative ‘Heart image’ to indicate an increasing level of affection. Conversely, a ‘Heart image’ can be animated to shrink from a large ‘Heart image’ to a smaller relative ‘Heart image’ to indicate a decreasing level of affection. It will be apparent to those of ordinary skill in the art that other variations of the animated relationship images can also be used to convey additional information regarding the relationship.

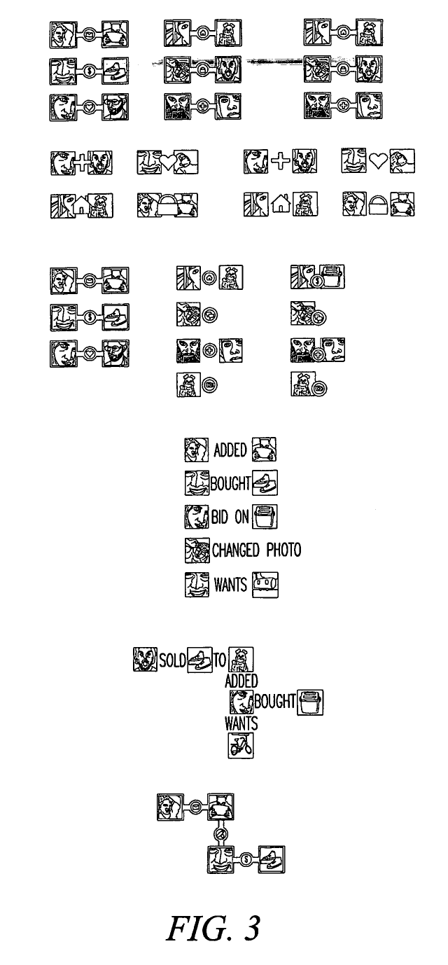

FIG. 3 illustrates a sample screenshot of other examples of the relationship visualizations of a particular embodiment. It will be appreciated that these visualizations can be rendered or modified in real-time as the condition of the indicated relationship changes. Given that the relationships are rendered as visualizations and not as text, the visualizations will be useful for all computing platforms, communication platforms, for any international setting, and for all native languages.

### APIs

Various embodiments include an application programming interface (API) for relationship visualizations. Various API calls can be provided to return a relationship visualization given an entity identifier or other input information that defines a desired relationship.

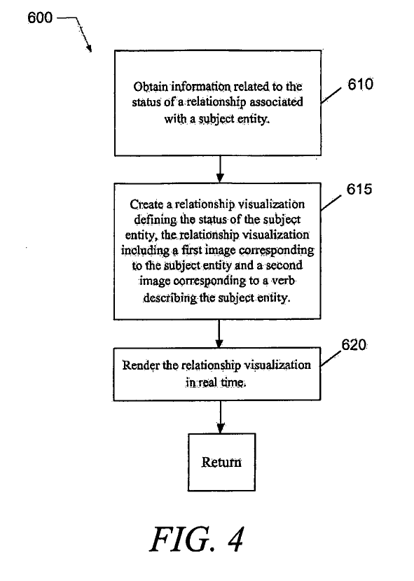

FIG. 4 is a processing flow diagram of an example embodiment. In the example embodiment, a method includes obtaining information related to the status of a relationship associated with a subject entity (processing block 610), creating a relationship visualization defining the status of the subject entity, the relationship visualization including a first image corresponding to the subject entity and a second image corresponding to a verb describing the subject entity (processing block 615); and rendering the relationship visualization in real time (processing block 620).

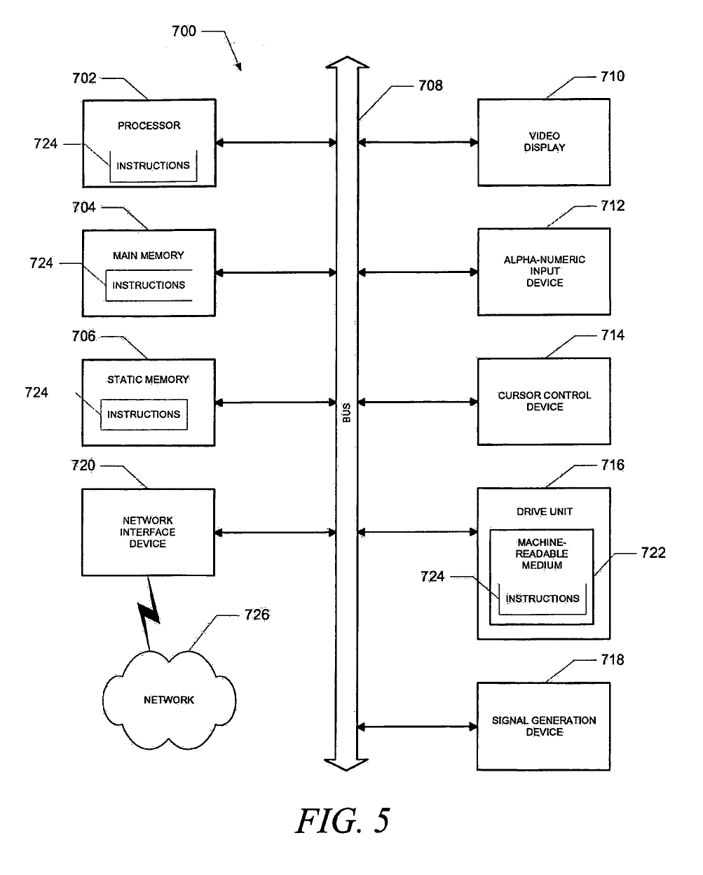

FIG. 5 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical and magnetic media, and carrier wave signals. As noted, the software may be transmitted over a network using a transmission medium. The term “transmission medium” shall be taken to include any medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

The system of an example embodiment may include software, information processing hardware, and various processing steps, which are described herein. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and apparatus described herein is equally applicable to other network infrastructures or other data communications systems.

Various embodiments are described herein. In particular, the use of embodiments with various types and formats of user interface presentations and/or application programming interfaces may be described. It can be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

Thus, a computer-implemented system and method for creating relationship visualizations in a networked system are disclosed. While the present invention has been described in terms of several example embodiments, those of ordinary skill in the art can recognize that the present invention is not limited to the embodiments described, but can be practiced with modification and alteration within the spirit and scope of the appended claims. The description herein is thus to be regarded as illustrative instead of limiting.

What is claimed is:

1. A method comprising:
obtaining information related to the status of a relationship associated with a subject entity;
creating a relationship visualization defining the status of the subject entity, the relationship visualization including a first image corresponding to the subject entity and a second image corresponding to a verb describing the subject entity; and
rendering the relationship visualization in real time.

2. The method as claimed in claim 1 wherein the relationship visualization including a third image corresponding to a direct object entity.

3. The method as claimed in claim 1 wherein the size of the second image is variable to indicate a significance or intensity of the corresponding verb.

4. The method as claimed in claim 1 wherein the color of the second image is variable to indicate a state of the corresponding verb.

5. The method as claimed in claim 1 wherein the relationship visualization is animated.

6. The method as claimed in claim 1 wherein the relationship visualization is provided via an application programming interface (API) call.

7. The method as claimed in claim 1 wherein the relationship is an e-commerce transaction.

8. The method as claimed in claim 1 wherein the relationship is a social interaction.

9. An apparatus comprising:
a relationship visualization generator configured to:
obtain information related to the status of a relationship associated with a subject entity;
create a relationship visualization defining the status of the subject entity, the relationship visualization including a first image corresponding to the subject entity and a second image corresponding to a verb describing the subject entity; and
render the relationship visualization in real time.

10. The apparatus as claimed in claim 9 wherein the relationship visualization including a third image corresponding to a direct object entity.

11. The apparatus as claimed in claim 9 wherein the size of the second image is variable to indicate a significance or intensity of the corresponding verb.

12. The apparatus as claimed in claim 9 wherein the color of the second image is variable to indicate a state of the corresponding verb.

13. The apparatus as claimed in claim 9 wherein the relationship visualization is animated.

14. The apparatus as claimed in claim 9 wherein the relationship visualization is provided via an application programming interface (API) call.

15. The apparatus as claimed in claim 9 wherein the relationship is an e-commerce transaction.

16. The apparatus as claimed in claim 9 wherein the relationship is a social interaction.

17. An article of manufacture comprising a machine-readable storage medium having machine executable instructions embedded thereon, which when executed by a machine, cause the machine to:
obtain information related to the status of a relationship associated with a subject entity;
create a relationship visualization defining the status of the subject entity, the relationship visualization including a first image corresponding to the subject entity and a second image corresponding to a verb describing the subject entity; and
render the relationship visualization in real time.

18. The article of manufacture as claimed in claim 17 wherein the relationship visualization including a third image corresponding to a direct object entity.

19. The article of manufacture as claimed in claim 17 wherein the size of the second image is variable to indicate a significance or intensity of the corresponding verb.

20. The article of manufacture as claimed in claim 17 wherein the color of the second image is variable to indicate a state of the corresponding verb.

21. The article of manufacture as claimed in claim 17 wherein the relationship visualization is animated.

22. The article of manufacture as claimed in claim 17 wherein the relationship visualization is provided via an application programming interface (API) call.

23. The article of manufacture as claimed in claim 17 wherein the relationship is an e-commerce transaction.

24. The article of manufacture as claimed in claim 17 wherein the relationship is a social interaction.
